(19) United States
(12) Patent Application Publication
(10) Pub. No.: US 2016/0005083 A1
(43) Pub. Date: Jan. 7, 2016

(54) Business Lead Generation System and Method Using Structured Social Media Content

(71) Applicant: P. ASHOK ANAND, Mylapore, Chennai (IN)

(72) Inventor: P. Ashok Anand, Chennai (IN)

(21) Appl. No.: 14/769,864

(22) PCT Filed: Feb. 25, 2014
(86) PCT No.: PCT/IN2014/000123

§ 371 Date: Aug. 24, 2015

(30) Foreign Application Priority Data
Feb. 25, 2013 (IN) 816/CHE/2013

(51) Int. Cl. G06Q 30/02; G06Q 50/00

(52) U.S. Cl. CPC G06Q 30/0269; G06Q 50/01; G06Q 30/0275

(57) ABSTRACT

This invention relates to a business lead generating system and method using structured social information. An intent capturing platform captures at least one structured activity including, but not limited to, planning a vacation, a house move, a birthday party etc. to generate at least one user intent with respect to the user. An intent driven computing application is provided for processing the captured user intents in order to thereby provide offers and coupons to the user/consumer. There is provided a plurality of information queues having relevant user intents which are categorized based on the nature of the intent for providing product/service information to the relevant companies and businesses in a social network environment. Such a business lead generation can be effectively adapted by a wide range of companies and business networks to leverage the business leads, targeting their advertisements to users whose interest best align with the products/services of a company/business.

### TECHNICAL FIELD

Embodiments are generally related to social networking environment. Embodiments are also related to business lead generation systems and methods. Embodiments are additionally related to methods and systems for generating business leads using structured social media contents.

### BACKGROUND OF THE INVENTION

The term “business lead generation” generally refers to the creation or generation of prospective consumer interest/inquiry into products or services of a business. A lead generation process is a business application that provides businesses with prospective customer contact information based on certain criteria. Many businesses adapt the lead generation applications/techniques to provide them with mailing lists either postal or email that contain prospective customers for its products or services. Providing lead lists to businesses can be a lucrative business because many businesses outsource the lead generation process to a third party to save time.

In a typical business-to-business marketing the lead-generation activities are typically carried out using a company website. More particularly, a target lead-generation system and method that targets the right businesses using real-time predictive and behavioral analytics and website traffic data connects businesses to potential customers/suppliers to drive business revenue. A real time searching and matching system can be adapted for real-time searching and matching of data input into website registration forms by website visitors in order to provide real-time cleansing and appending of attribute rich company demographic data to the website form and to the marketing database. The resulting information can be available for use by other systems such as marketing automation systems and CRM systems.

In recent past, businesses are showing increasing interest in lead generation using the Internet. With the advent of social networks, or social utilities that track and enable connections between users including people, businesses, and other entities, have become prevalent. In particular, social network systems allow users to communicate information efficiently. For example, a user may post contact information, background information, job information, hobbies, and/or other user-specific data to a location associated with the user on a social network system. Other users can then review the posted data by browsing user profiles or searching for profiles including specific data.

Nom Most of the prior art business lead generation systems and methods typically collect the user information posted on an un-structured social platform in order to convert into a streamlined/structured social media content. Such social media contents are further processed in order to indentify and generate appropriate business leads to the companies. The business networks/companies may further adapt the generating business leads to develop a marketing action plan to their target customers. Converting un-structured social media contents into structured social media information can be cumbersome and time consuming using such prior art lead generation systems. Further, a manual process of analyzing and processing the business leads and developing a marketing action plan can be tedious to companies which may not lead them to leverage the maximum marketing potential of the business leads.

Based on the foregoing, it is believed that a need exists for an improved business lead generation system and method. A need also exists for an improved system and method for generating business leads using structured social media content in a social media network, as described in detail herein.

### SUMMARY OF THE INVENTION

The following summary is provided to facilitate a understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved business lead generating system and method.

It is another aspect of the disclosed embodiments to provide for an improved method for generating business leads to companies/businesses in a social network environment.

It is further aspect of the disclosed embodiments to provide for an improved system and method for generating business leads using structured social media information.

The aforementioned aspects and other objectives and advantages can now be achieved as described herein. A business lead generating system and method using structured social information, is disclosed herein. An intent capturing platform captures at least one structured activity including, but not limited to, planning a vacation, a house move, a birthday party etc, in order to thereby generate at least one user intent with respect to the user. An intent driven computing application for processing the captured user intents in order to thereby provide offers and coupons to the user/consumer. A plurality of information queues having relevant user intents which are categorized based on the nature of the intent for providing product/service information to the relevant companies and businesses in a social network environment. Such a business lead generation can be effectively adapted by a wide range of companies and business networks to leverage the business leads, targeting their advertisements to users whose interest best align with the products/services of a company/business.

The business lead generation system and method proposed herein provides a unique platform for capturing the lifestyle structured activities of a customer/user in order to generate accurate user intents with respect to a business/company. The user intents generated by the intent generating platform can be a one-off activity to a complex structured activity. The platform can be completely secure with publication of plans or user intents at the discretion of the user/customer. Optionally, the user can be permitted to keep the plans and user intents private/make them public the social network ecosystem. The user intents generated by the intent capturing platform can be moved to a public domain or an advertiser realm in order to make the user intents actionable information for advertisers, marketers and enterprises to thereby provide meaningful information to the users staking a claim for their business/purchase.

The user intents can be also adapted to communicate the ad widgets, coupons, direct offers, etc to the user/customer within the social networking environment. The business lead generation system permits the users to associate themselves with other users, thus creating a web of connections among the users which can be exploited by the businesses to offer more relevant information to each user in view of the users' own stated interests in their connections. Such an application permits the users to choose the best offers and deals with respect to their intents without the need of visiting the individual vendor portal/premises.

The information queues having the relevant user intents can be captured and made available to the companies/business depending on the size of the information queue. The companies/businesses may further purchase an information queue of a given size in order thereby subscribe to product/service categories they are interested in receiving through the queue. The business lead generation system described herein permits the companies/businesses to post a sponsored plan with respect to the targeted users/customers in order thereby permit the users to choose an optimal choice of sponsored plan. The business lead generation system also initiates a reverse auction automatically at the instance of the user for certain commodity products and provide the best offer to the user in the social network environment. The vendors can typically bid in the reverse auction in order to provide a best offer for a customer/user.

The lead generation system also connects users to content that is most likely to be relevant to each user. For example, users may be grouped according to one or more common attributes in their profiles, such as geographic location, employer, job type, age, music preferences, interests, or other attributes. The users within the network can access these groups to customize or target information delivery so that information that might be of particular interest to a group can be communicated to that group. Such a platform provides a “plan and publish” model of approach to a wide range of customers/users where the users can publish their clear actionable information to get an appropriate best buying option in the social media regime.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a graphical representation of a business lead generation system, in accordance with the disclosed embodiments;

FIG. 2 illustrates a block diagram of a business lead generation system, in accordance with the disclosed embodiments; and

FIG. 3 illustrates a high level flow chart of operation illustrating logical operating steps of a method for generating business lead with respect to company/business, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

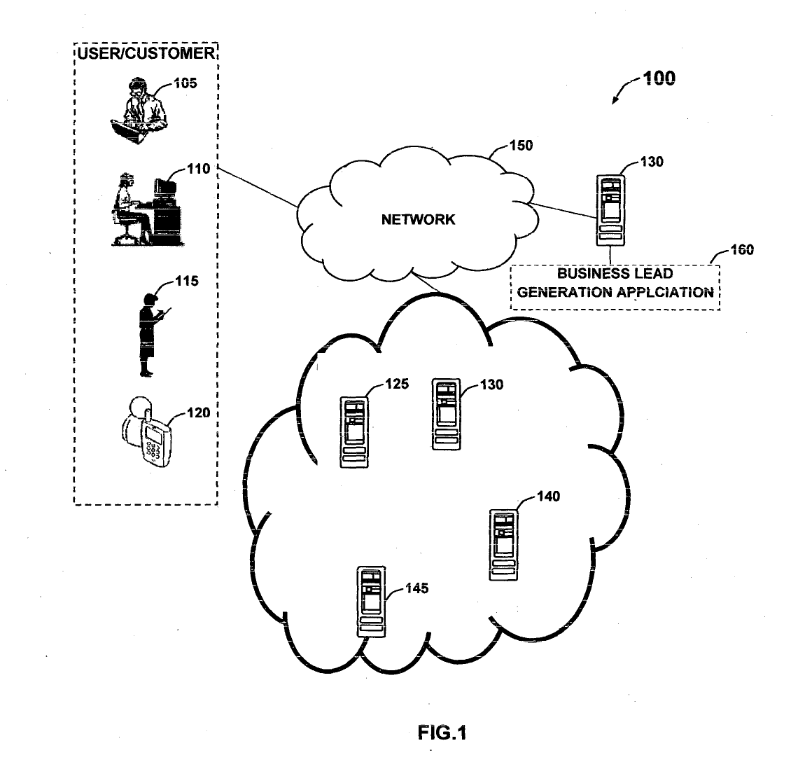

FIG. 1 illustrates a graphical representation of a business lead generation system 100, in accordance with the disclosed embodiments. The business lead generation system 100 disclosed herein can be an effective lead generation platform that provides an interactive environment for businesses to connect with one another and share resources. Such a platform empowers the businesses to compete at the level of much larger businesses by pooling the resources of the businesses and allowing each customer participating in the pool to have access to the resources therein. The business lead generation system 100 generally includes a lead generation server 130 having a business lead generation application 160, at least one company/business server such as business servers 125, 130, 140 and 145, a plurality of social network users such as users'105, 110, 115, and 120 respectively, that are operatively connected via a network 150. Note that the term “company/business server” 125-145 should not be constituted in any limited sense; the company/business server 125-145 can be such as for example, but not limited to, advertisers, marketers and enterprises etc.

Note that the business lead generation system 100 described herein may include hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and non-removable media, and media readable by a database, a switch, and various other network devices.

In the depicted example, the company/business server 125-145 provides data, such as business information, offers, product details, business location information, pricing, discounts, etc, to the users 105-120. Users/customers 105-120 may be existing/new clients to the business servers 125-145 in this example, network 150 may include additional business servers, users, and other devices not shown. Specifically, customers 105-120 may connect to any member of a network of business servers 125-145 which provide equivalent content.

In the depicted example, network 150 represents a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network 1 also may be implemented as a number of different types of networks, such as for example, an intranet, a local area network (LAN), or a wide area network (WAN).

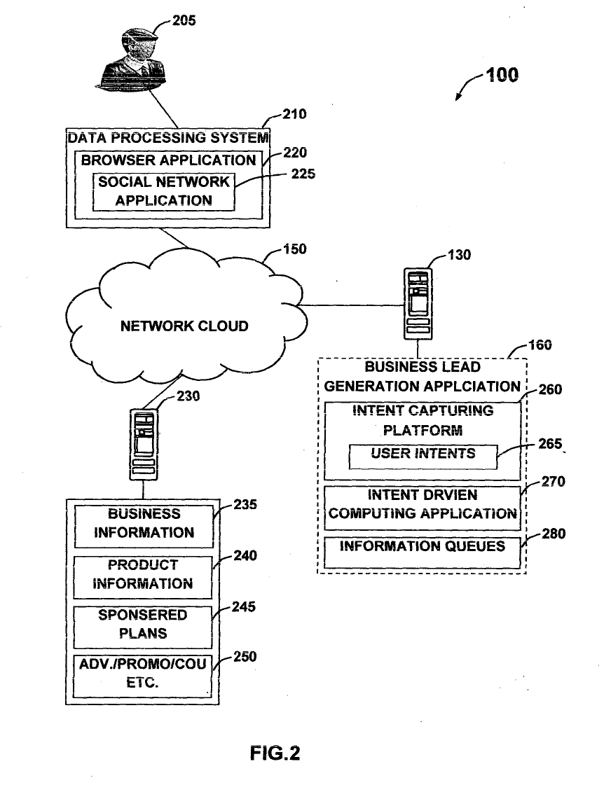

FIG. 2 illustrates a block diagram of a business lead generation system 100, in accordance with the disclosed embodiments. Note that in FIGS. 1-3 identical parts or elements are generally indicated by identical reference numerals. The business lead generation application 160 of the business lead generation system 130 includes an intent capturing application 260 for generating at least one user intent 265 with respect to the user 205. Note that the user 205 can be for example, any customer/user 105-120 as depicted in FIG. 1. The intent capturing platform 260 captures at least one structured activity including, but not limited to, planning a vacation, a house move, a birthday party etc, with respect to the user 205 in order to thereby generate the user intents 265.

The user 205 may typically access a data processing system 210 having a browser application 220 such as, for example, Firefox®, Google Chrome®, or any other browser application that is well known in the art to provide his/her intents in the social network application 225. As illustrated in FIG. 2, the data-processing system 210 can be a general purpose computing device having a central processor, a main memory, an input/output controller, a keyboard, an input device (e.g., a pointing device, such as a mouse, track ball, pen device, etc), a display device, a mass storage (e.g., a hard disk), and a USB (Universal Serial Bus) peripheral connection. Additional input/output devices, such as a rendering device (e.g., printer, scanner, fax machine, etc), for example, may be associated with the data-processing system 210 as desired.

The browser 220 can be a software application, stored in main memory and on mass storage, generally includes a kernel or operating system and a shell or interface. One or more application programs may be “loaded” (i.e., transferred from mass storage- into the main memory) for execution by the data-processing system 210. The data-processing system 210 receives user commands and data through the browser application 220; these inputs may then be acted upon by the data-processing system 210 in accordance with instructions from operating system and/or social network application 225. Note that the data processing system 210 can be implemented at the business server system end 230 alternatively. A person skilled in the art may appreciate the usage of the data processing system 210 as intended.

The intent driven computing application 270 for processing the captured user intents 265 in order to thereby provide offers and coupons to the user/consumer. A plurality of information queues 280 having relevant user intents 265 which are categorized based on the nature of the intent 265 for providing product/service information to the relevant companies and businesses in the social network environment. The company server 230 may provide at least one business information 235, product information 240, sponsored plans 245 and advertisements, promotions 250 with respect to the user 205 depending on the captured user intents 265.

The business lead generation system 100 proposed herein provides a unique platform for capturing the lifestyle structured activities of the customer/user 205 in order to generate accurate use intents 265 with respect to the business/company 230. The user intents 265 generated by the intent capturing platform 260 can be a one-off activity to a complex structured activity. The platform 260 can be completely secure with publication of plans or user intents 265 at the discretion of the user/customer 205. Optionally, the user 205 can be permitted to keep the plans and user intents 265 private/make them public the social network ecosystem. The user intents 265 generated by the intent capturing platform 260 can be moved to a public domain or an advertiser realm in order to make the user intents 265 actionable information for advertisers, marketers and enterprises to thereby provide meaningful information to the users 205 staking a claim for their business/purchase.

The user intents 265 can be also adapted to communicate the ad widgets, coupons, direct offers, etc to the user/customer 205 within the social networking environment. The business lead generation system 100 permits the users 205 to associate themselves with other users, thus creating a web of connections among the users which can be exploited by the businesses to offer more relevant information to each user in view of the users' own stated interests in their connections. Such an application permits the users 205 to choose the best offers and deals with respect to their intents 265 without the need of visiting the individual vendor portal/premises.

The information queues 280 having the relevant user intents 265 can be captured and made available to the companies/business 230 depending on the size of the information queue 280. The companies/businesses 230 may further purchase an information queue 280 of a given size in order thereby subscribe to product/service categories they are interested in receiving through the queue 280. The business lead generation system 100 described herein permits the companies/businesses 230 to post a sponsored plan 245 with respect to the targeted users/customers 205 in order thereby permit the users-205 to choose an optimal choice of sponsored plan 245. The business lead generation system 100 also initiates a reverse auction automatically at the instance of the user 205 for certain commodity products and provide the best offer to the user 105 in the social network environment. The vendors can typically bid in the reverse auction in order to provide a best offer for the customer/user 205.

The lead generation system 100 also connects users 205 to content that is most likely to be relevant to each user. For example, users 205 may be grouped according to one or more common attributes in their profiles, such as geographic location, employer, job type, age, music preferences, interests, or other attributes. The users 205 within the network 150 can access these groups to customize or target information delivery so that information that might be of particular interest to a group can be communicated to that group. Such a platform provides a “plan and publish” model of approach to a wide range of customers/users 205 where the users can publish their clear actionable information to get an appropriate best buying option in the social media regime.

FIGS. 1-3 are thus intended as an example, and not as an architectural limitation with respect to particular embodiments. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms, including Macintosh, Windows, UNIX, LINUX, and the like.

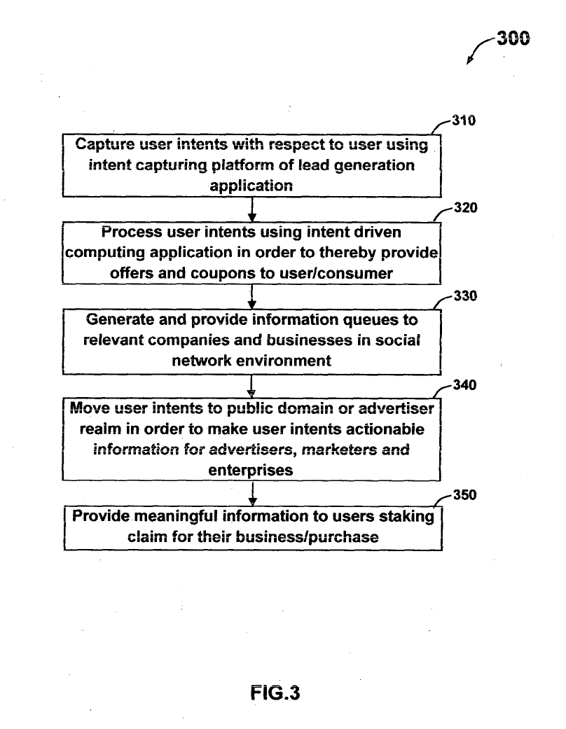

FIG. 3 illustrates a high level flow chart of operation illustrating logical operating steps of a method 300 for generating business lead with respect to company/business 230, in accordance with the disclosed embodiments. Note that the method 300 can be implemented in the context of a computer-useable medium that contains a program product, including, for example, a module or group of modules. The user intents 265 with respect to the user 205 can be captured using the intent capturing platform 260 of the lead generation application 160, as illustrated at block 310. The user intents 265 can be captured by capturing at least one structured activity including, but not limited to, planning a vacation, a house move, a birthday party etc, with respect to the user 205. The user intents 265 can be processed using the intent driven computing application 270 in order to thereby provide offers and coupons to the user/consumer 205, as depicted at block 320.

The information queues 280 having relevant user intents 265 which are categorized based on the nature of the intent 265 can be generated and provided to the relevant companies and businesses 230 in the social network environment, as shown at block 330. The user intents 265 generated by the intent capturing platform 260 can be moved to the public domain or advertiser realm in order to make the user intents 265 actionable information for advertisers, marketers and enterprises to thereby provide meaningful information to the users staking a claim for their business/purchase, as illustrated at blocks 340 and 350. Such a business lead generation system and method can be effectively adapted by a wide range of companies and business networks to leverage the business leads, targeting their advertisements to users whose interest best align with the products/services of a company/business.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A business lead generating system using structured social information, said system comprising:
an intent capturing platform captures at least one structured activity to generate at least one user intent with respect to a user;
an intent driven computing application for processing said at least one captured user intent to provide offers and coupons to the user/consumer; and
a plurality of information queues having said at least one relevant user intent which is categorized based on the nature of said intent for providing product/service information to the relevant companies and business in a social network environment.

2. The system of claim 1 wherein said intent capturing platform provides a unique platform for capturing the lifestyle structured activities of said user in order to generate said accurate user intents with respect to a business/company.

3. The system of claim 1 wherein said at least one user intent can be a one-off activity to a complex structured activity.

4. The system of claim 1 wherein said plurality of information queues having said at least one relevant user intents can be captured and made available to said companies/business depending on a size of the information queue, wherein said companies/businesses may further purchase said information queue of a given size to subscribe to product/service categories they are interested in receiving through the queue.

5. The system of claim 1 comprising a sponsored plan which can be posted by said companies/businesses with respect to said targeted user/customers to permit the users to choose an optimal choice of said sponsored plan.

6. The system of claim 1 comprising a reverse auction which automatically initiated at the instance of said user for certain commodity products and provides a best offer to the user in the social network environment wherein the a vendor can typically bid in said reverse auction to provide a best offer for said customer/user.

7. The system of claim 1 wherein said user intents generated by said intent capturing platform can be moved to a public domain or an advertiser realm to make said user intents actionable information to thereby provide meaningful information to users staking a claim for a business/purchase.

8. The system of claim 1 wherein said intent capturing platform enables said users to associate with other users, thus creating a web of connections among the users which can be exploited by the businesses to offer relevant information to each user in view of the users' own stated interests in the user's connections.

9. The system of claim 1 wherein said intent capturing platform also connects users to content that is most likely to be relevant to each user to form a user group wherein said users in said user group receive customized or targeted information that might be of interest to said user group.

10. The system of claim 1 wherein said users are allowed to associate with other users, thus creating a web of connections among said users which can be used by businesses to offer more relevant information to each said user in view of the users' own stated interests in the user's connections.
